(19) United States
(12) Patent Application Publication
(10) Pub. No.: US 2006/0010248 A1
(43) Pub. Date: Jan. 12, 2006

(54) Document processing management system and method

(76) Inventors: Brenda Daos, Mission Viejo, CA (US); Vincent Wu, Irvine, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/888,030

(22) Filed: Jul. 9, 2004

(51) Int. Cl. G06F 15/173

(52) U.S. Cl. 709/238

(57) ABSTRACT

This invention is directed to a system and method for document processing management. More particularly, this invention is directed to a document processing management system and method for routing and handling jobs which have missing or invalid identification data, such as user name, password, department code, and the like.

### BACKGROUND OF THE INVENTION

This invention is directed to a document processing management system and method. More particularly, this invention is directed to a document processing management system and method for routing and handling jobs which have missing or invalid identification data, such as user name, password, department code, and the like.

Typically, document processing devices in office environments, or other environments in which a plurality of users share the device, users are required provide identification data, such as user name, password, or department code, with the processing request to track usage and properly charge the jobs to the correct user or department. A system administrator or other authorized user generally will establish policies relating usage control and billing procedures and will not allow jobs without the appropriate identification data to be processed. Jobs without the proper identification data are sent to a holding area or storage medium. Such jobs will remain in the holding area taking up valuable memory space, especially large processing jobs, until the proper identification data is provided, if it is ever provided. The user or system administrator must have notice of the missing or invalid data and then must provide the correct data for the job to be removed from the holding area and processed. There is a need for a document processing system and method for routing and handling jobs which have missing or invalid identification data.

The subject invention overcomes the above-noted limitations and provides a system and method for routing and handling jobs which have missing or invalid identification data.

### SUMMARY OF THE INVENTION

In accordance with the present invention, there is provided a system and method for document processing management.

Further, in accordance with the present invention, there is provided a document processing management system and method for routing and handling jobs which have missing or invalid identification data, such as user name, password, department code, and the like.

Further, in accordance with the present invention, there is provided a document processing system and method for routing and handling jobs which do not have the correct identification data which does not use valuable memory for extended periods of time.

Still further, in accordance with the present invention, there is provided a document processing management system. The system comprises means adapted for receiving document processing job data associated with processing of at least one associated electronic document. The document processing job data includes an identification data segment adapted to communicate identifier data representative of at least one of a user identity and accounting information associated with the at least one electronic document. The system also comprises testing means adapted for testing the identification data relative to data representative of valid document processing jobs, the testing means including means adapted for generating a status signal representative of at least one of missing identification data and invalid identification data. The system further comprises routing means adapted for generating a routing signal in accordance with the status signal so as to route the associated electronic document to an associated temporary storage after generation of the status signal and means adapted for outputting the status signal as a notification that the associated document has been routed to the temporary storage. The document processing operations preferably include printing, scanning, facsimile, copying, and optical character recognition operations.

In a preferred embodiment, the system also includes means adapted for communicating the status signal to at least one of a system administrator and a user associated with the processing of the at least one associated electronic document. Preferably, the system also comprises means adapted for receiving additional identifier data in accordance with a communicated status signal and means for testing the additional identifier data, whereby a status signal is generated therefrom. In a preferred embodiment, the user or system administrator is only allowed to enter such additional identifier data a selected number of attempts, after which the document is sent to a temporary storage area or deleted.

In a preferred embodiment, the system further comprises means adapted for acquiring timing data representative of a duration of time during which the associated document has been placed in the temporary storage. Preferably, the system additionally includes means adapted for communicating the status signal to at least one of a system administrator and a user associated with the processing of the at least one associated electronic document. The system also includes means adapted for receiving additional identifier data in accordance with a communicated status signal and means adapted for selectively releasing the associated electronic document from the temporary storage and deleting the document from the temporary storage in accordance with the timing data and the additional identifier data.

In another embodiment, the system comprises means adapted for receiving document processing job data associated with processing of at least one associated electronic document. The document processing job data includes an identification data segment adapted to communicate identifier data representative of at least one of a user identity and accounting information associated with the at least one electronic document. The system also comprises testing means adapted for testing the identification data relative to data representative of valid document processing jobs, the testing means including means adapted for generating a status signal representative of at least one of missing identification data and invalid identification data. The system further comprises operational control signal generation means for generating an operational control signal in accordance with the status signal to control the specified document processing after receipt of the status signal and means adapted for outputting the status signal as a notification that the associated document has at least one of missing identification data and invalid identification data.

Still further, in accordance with the present invention, there is provided a document processing management method. The method comprises receiving document processing job data associated with processing of at least one associated electronic document. The document processing job data includes an identification data segment adapted to communicate identifier data representative of at least one of a user identity and accounting information associated with the at least one electronic document. The method also comprises testing the identification data relative to data representative of valid document processing jobs, including generating a status signal representative of at least one of missing identification data and invalid identification data. The method further comprises generating a routing signal in accordance with the status signal so as to route the associated electronic document to an associated temporary storage after generation of the status signal and outputting the status signal as a notification that the associated document has been routed to the temporary storage. The document processing operations preferably include printing, scanning, facsimile, copying, and optical character recognition operations.

In a preferred embodiment, the method also includes communicating the status signal to at least one of a system administrator and a user associated with the processing of the at least one associated electronic document. The method also preferably comprises receiving additional identifier data in accordance with a communicated status signal and testing the additional identifier data, whereby a status signal is generated therefrom. In a preferred embodiment, the user or system administrator is only allowed to enter such additional identifier data a selected number of attempts, after which the document is sent to a temporary storage area or deleted.

In a preferred embodiment, the method further comprises for acquiring timing data representative of a duration of time during which the associated document has been placed in the temporary storage. Preferably, the method additionally includes communicating the status signal to at least one of a system administrator and a user associated with the processing of the at least one associated electronic document. The method also includes receiving additional identifier data in accordance with a communicated status signal and selectively releasing the associated electronic document from the temporary storage and deleting the document from the temporary storage in accordance with the timing data and the additional identifier data.

In another embodiment, the method comprises receiving document processing job data associated with processing of at least one associated electronic document. The document processing job data includes an identification data segment adapted to communicate identifier data representative of at least one of a user identity and accounting information associated with the at least one electronic document. The method also comprises testing the identification data relative to data representative of valid document processing jobs, including generating a status signal representative of at least one of missing identification data and invalid identification data. The method further comprises generating an operational control signal in accordance with the status signal to control the specified document processing after receipt of the status signal and outputting the status signal as a notification that the associated document has at least one of missing identification data and invalid identification data.

Still other objects and aspects of the present invention will become readily apparent to those skilled in this art from the following description wherein there is shown and described a preferred embodiment of this invention, simply by way of illustration of one of the best modes suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a block diagram of the system according to the present invention;

FIG. 2 is a flow chart illustrating the method according to the present invention; and

FIG. 3 is a flow chart illustrating the process for routing or handling of a job that missing or invalid identification data.

### DETAILED DESCRIPTION OF THE PREFERRED EMBODIMENT

This invention is directed to a system and method for document processing management. More particularly, this invention is directed to a document processing management system and method for routing and handling jobs which have missing or invalid identification data, such as user name, password, department code, and the like.

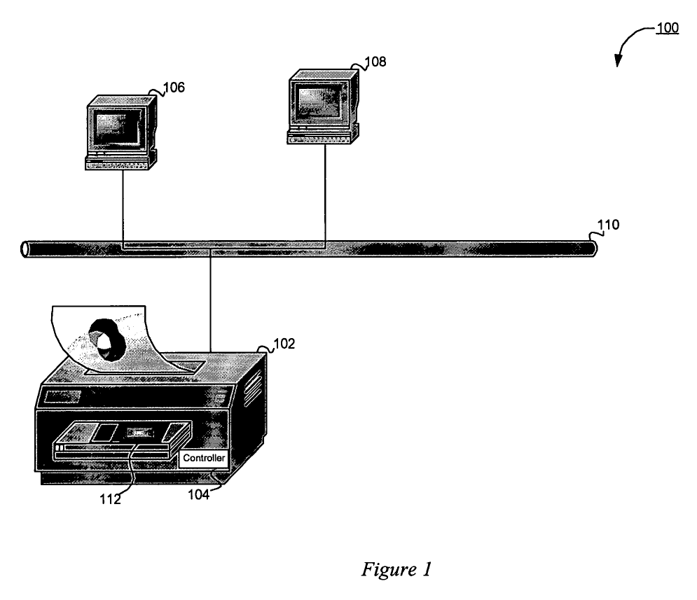

Referring to FIG. 1, there is shown an exemplary system 100 for routing document processing operations according to the present invention. The system 100 comprises a document processing device 102. The document processing device 102 of system 100 includes a controller 104, typically comprising a processor component, associated memory and a communications component. The controller 104 functions to control the document processing device 102, directing the document processing device 102 operations and enabling communications between the document processing device 102 and other devices. Preferably, the document processing device is a printing device, a copying device, a scanning device, a facsimile, or a multifunctional peripheral device.

For example, as shown in FIG. 1, the system 100 resides on a computer network 110, allowing multiple computers 106, 108 to communicate and use the capabilities of the document processing device 102. The network 110 is suitably any suitable network known in the art, for example and without limitation, Ethernet, Token Ring, or the Internet. The computers 106 and 108 transmit data to the document processing device 102 through the controller 104 over the computer network 110. It will be appreciated by those skilled in the art that the document processing device 102 need not be coupled to the computer network 110, but rather is suitably in a stand-alone mode, i.e. connected to a single computer. The skilled artisan will understand that such a stand-alone configuration will not affect the operation of the present invention with respect thereto. Those skilled in the art will appreciate that the document processing device 102 is suitably any document processing device known in the art, including but not limited, for example, the Toshiba e-Studio Series Controller.

The document processing device is in data communication with an associated user interface 112 by which an associated user requests document processing operations and selects the parameters associated therewith. Preferably, the user interface preferably includes a display means for displaying information related to document processing operations. In one embodiment, the user interface is a display means or monitor attached to or associated with the document processing device wherein the user uses the interface to access or modify the information about the document processing operations. In another embodiment, the user accesses or modifies such information remotely via a remote user interface, such as via a web administrator, connected to the document processing device via any suitable means. It will be appreciated that viable user interfaces suitably take various forms, such as touch screen, keypads, pen input, and the like.

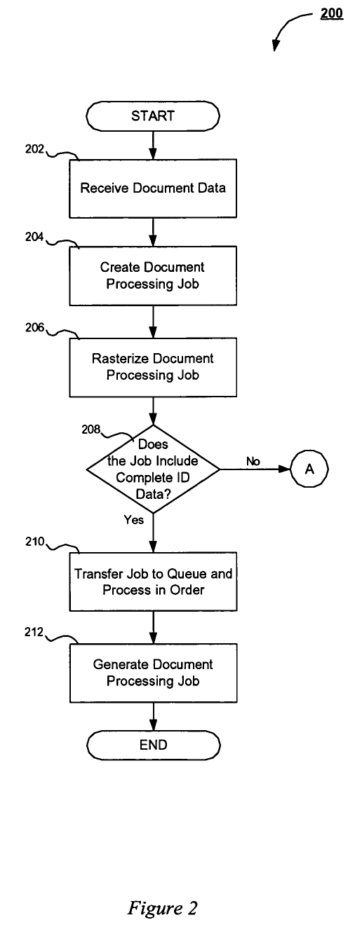

FIG. 2 is a flowchart 200 illustrating the method for routing document processing operations according to the present invention. At 202, a document processing job is received at the document processing device via any suitable means known in the art. Preferably, the document data is received at a spooling means within the document processing device upon the request from the associated user for generating the document. Preferably, the parameters for generating the document and information related to the document processing operation are also transmitted to the document processing device.

At 204, the document processing job is created via any suitable means. Preferably, the document processing job is created by job managing means within the controller in the document processing device. At 206, the document file is prepared for generating via any suitable means. Preferably, the document file is rasterized by a RIP manager means within the document processing device.

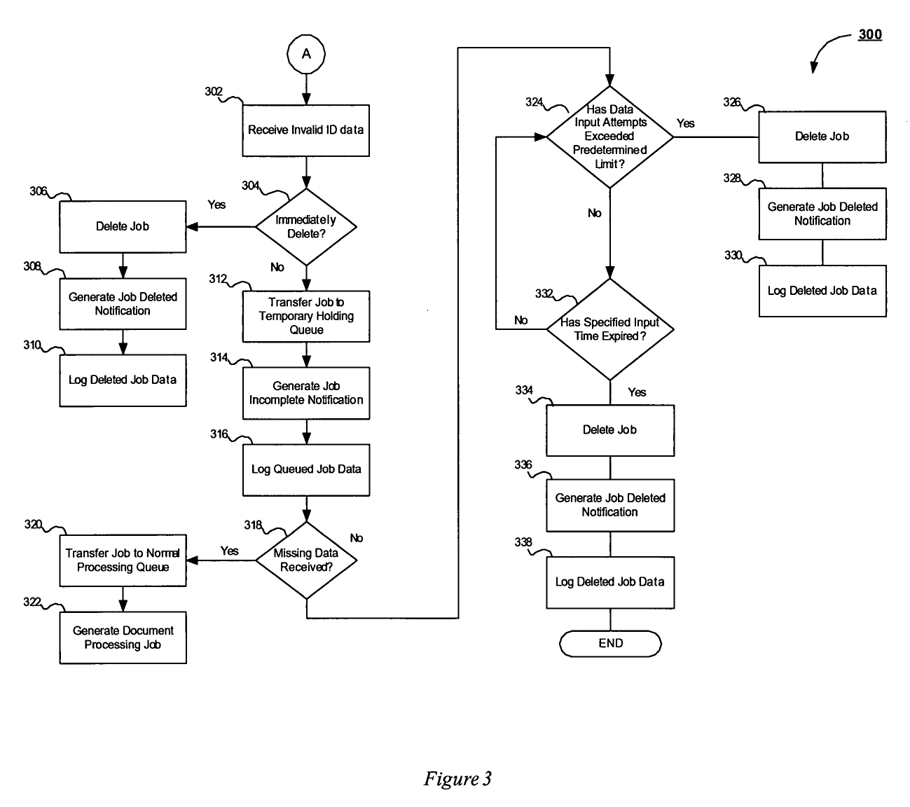

At 208, a determination is made via any suitable means as will be readily understood by one or ordinary skill in the art, whether the document processing job includes correct and complete identification or authorization data. (How will this be done?). Such determination is preferably performed without any user intervention or interaction. If the document processing job contains missing or invalid identification data, flow proceeds to 302 as shown in FIG. 3 and described in detail below.

If the document processing job contains correct and complete identification data, flow proceeds to 210, wherein the document processing job is transferred to a normal processing queue and processed in the order specified in the queue. At 212, the document processing job is suitably generated.

FIG. 3 is a flowchart illustrating the process for routing or handling a document processing job that contains missing or invalid identification data. At 302, the document processing device or system has determined that the document processing job does not contain the required information. The identification data or information required for a job to be processed is determined or selected by any suitable means. Preferably, a system administrator or other authorized user sets a usage or tracking policy which is programmed or set in the document processing system via any suitable means. When a processing job does not contain the required information, the processing jobs is not allowed to be completed without such information.

Flow then proceeds to 304, wherein a determination is made whether the job is to be immediately deleted. In one embodiment, the user requesting the job suitably instructs the system to delete immediately any jobs that cannot be processed. Such instructions are received via any suitable means in the art, such as when selecting the parameters associated with the job. In another embodiment, a system administrator or other authorized user sets the parameters or program for the system such that any job or selected jobs that cannot be processed is immediately deleted via any suitable means.

In the event the job is to be immediately deleted, flow proceeds to 306, wherein the job is suitable deleted means. At 308, a notification is generated that the job was not able to be processed and was deleted. The notification is preferably transmitted to at least one of the user and a system administrator via any suitable means. At 310, data relating to the job and that the job is not able to be processed is logged. Preferably, the data is logged in a database or other storage medium associated with or connected to the document processing device.

If the job is not be immediately deleted, flow proceeds to 312, wherein the job is moved to a storage medium or temporary holding queue. At 314, a notification is generated and preferably transmitted to at least one of the associated user or system administrator notifying such person that the job is incapable of being processed as it the identification data is missing or incomplete and is in the holding queue. The user or system administrator then is able to input the correct or missing identification data via any suitable means to allow processing. The job is held in the holding queue for a specified amount of time. Such time is determined via any suitable means, such as by the system administrator or authorized user when setting the parameters for the document processing device.

In a preferred embodiment, data relating to the job held in the holding queue is logged via any suitable means as shown at 316. Preferably, the data is logged in a database or other storage medium associated with or connected to the document processing device. Such log is suitably viewed or displayed via any suitable means by the user or system administrator. In the event one of the jobs in the holding queue is a confidential job, the user must have the proper authorization to view the details of such job.

At 318, a determination is made whether the correct or missing identification data has been received such that the job is able to be processed. If the job is able to be processed, flow proceeds to 320, wherein the document processing job is transferred to a normal processing queue and processed in the order specified in the queue. At 322, the document processing job is generated.

If the correct or missing identification data has not been received, then flow proceeds to 324, wherein a determination is made whether the user or system administrator has attempted to input the correct or missing identification data and failed to provide the correct or missing data more than a set number of attempts. The specified number of attempts is determined via any suitable means, such as by the system administrator or authorized user when setting the parameters for the document processing device. If the user or system administrator has attempted to input the correct or missing identification data more than the allowed number of attempts, flow proceeds to 326, wherein the job is deleted via any suitable means. At 328, a notification is generated that the job was not able to be processed and was deleted. The notification is preferably transmitted to at least one of the user and a system administrator via any suitable means. At 330, data relating to the job and that the job is not able to be processed is logged. Preferably, the data is logged in a database or other storage medium associated with or connected to the document processing device.

If the number of attempts to input the correct or missing identification data has not been exceeded, then flow proceeds to 332, wherein a determination is made whether the specified time has expired for inputting the required information. If time has not expired, flow returns to 324 to await for the user to input the required information.

If the time has expired, flow proceeds to 334 wherein the job is deleted. At 336, a notification is generated that the job was not able to be processed and was deleted. The notification is preferably transmitted to at least one of the user and a system administrator. At 338, data relating to the job and that the job is not able to be processed is logged. Preferably, the data is logged in a database or other storage medium associated with or connected to the document processing device.

While in the preferred embodiment the present invention is implemented in software, as those skilled in the art can readily appreciate it may also be implemented in hardware or a combination of software and hardware.

Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

What is claimed:

1. A document processing management system comprising:
means adapted for receiving document processing job data associated with processing of at least one associated electronic document, the document processing job data including an identification data segment adapted to communicate identifier data representative of at least one of a user identity and accounting information associated with the at least one electronic document;
testing means adapted for testing the identification data relative to data representative of valid document processing jobs, the testing means including means adapted for generating a status signal representative of at least one of missing identification data and invalid identification data;
routing means adapted for generating a routing signal in accordance with the status signal so as to route the associated electronic document to an associated temporary storage after generation of the status signal; and
means adapted for outputting the status signal as a notification that the associated document has been routed to the temporary storage.

2. The document processing management system of claim 1 including means adapted for communicating the status signal to at least one of a system administrator and a user associated with the processing of the at least one associated electronic document.

3. The document processing management system of claim 2 including means adapted for receiving additional identifier data in accordance with a communicated status signal.

4. The document processing management system of claim 3 wherein the testing means further includes means adapted for testing the additional identifier data, whereby a status signal is generated therefrom.

5. The document processing management system of claim 4 wherein the testing means further includes means adapted for allowing at least one of the system administrator and the associated user to input additional identifier data a predetermined number of times and means adapted for determining whether such additional identifier data has been received such number of times, wherein if such additional identifier data has been received such number of times, additional identifier data is prohibited from being received.

6. The document processing management system of claim 2 further comprising means adapted for acquiring timing data representative of a duration of time during which the associated document has been placed in the temporary storage.

7. The document processing management system of claim 6 further comprising:
means adapted for communicating the status signal to at least one of a system administrator and a user associated with the processing of the at least one associated electronic document;
means adapted for receiving additional identifier data in accordance with a communicated status signal; and
means adapted for selectively releasing the associated electronic document from the temporary storage and deleting the document from the temporary storage in accordance with the timing data and the additional identifier data.

8. The document processing management system of claim 1 wherein the document processing job include printing, scanning, facsimile, copying, and optical character recognition jobs.

9. A document processing management method comprising the steps of:
receiving document processing job data associated with processing of at least one associated electronic document, the document processing job data including an identification data segment adapted to communicate identifier data representative of at least one of a user identity and accounting information associated with the at least one electronic document;
testing the identification data relative to data representative of valid document processing jobs, including generating a status signal representative of at least one of missing identification data and invalid identification data;
generating a routing signal in accordance with the status signal so as to route the associated electronic document to an associated temporary storage after generation of the status signal; and
outputting the status signal as a notification that the associated document has been routed to the temporary storage.

10. The document processing management method of claim 9 including the step of communicating the status signal to at least one of a system administrator and a user associated with the processing of the at least one associated electronic document.

11. The document processing management method of claim 10 including the step of receiving additional identifier data in accordance with a communicated status signal.

12. The document processing management method of claim 11 wherein the step of testing the identification data further includes testing the additional identifier data, whereby a status signal is generated therefrom.

13. The document processing management method of claim 12 wherein the step of testing the identification data further includes allowing at least one of the system administrator and the associated user to input additional identifier data a predetermined number of times and determining whether such additional identifier data has been received such number of times, wherein if such additional identifier data has been received such number of times, additional identifier data is prohibited from being received.

14. The document processing management method of claim 10 further comprising the step of acquiring timing data representative of a duration of time during which the associated document has been placed in the temporary storage.

15. The document processing management method of claim 14 further comprising the steps of:
communicating the status signal to at least one of a system administrator and a user associated with the processing of the at least one associated electronic document;
receiving additional identifier data in accordance with a communicated status signal; and
selectively releasing the associated electronic document from the temporary storage and deleting the document from the temporary storage in accordance with the timing data and the additional identifier data.

16. The document processing management method of claim 9 wherein the document processing job include printing, scanning, facsimile, copying, and optical character recognition jobs.

17. A computer-readable medium for instructions for document processing management comprising:
instructions for receiving document processing job data associated with processing of at least one associated electronic document, the document processing job data including an identification data segment adapted to communicate identifier data representative of at least one of a user identity and accounting information associated with the at least one electronic document;
instructions for testing the identification data relative to data representative of valid document processing jobs, including instructions for generating a status signal representative of at least one of missing identification data and invalid identification data;
instructions for generating a routing signal in accordance with the status signal so as to route the associated electronic document to an associated temporary storage after generation of the status signal; and
instructions for outputting the status signal as a notification that the associated document has been routed to the temporary storage.

18. The computer-readable medium of instructions for document processing management of claim 17 including instructions for communicating the status signal to at least one of a system administrator and a user associated with the processing of the at least one associated electronic document.

19. The computer-readable medium of instructions for document processing management of claim 18 including instructions for receiving additional identifier data in accordance with a communicated status signal.

20. The computer-readable medium of instructions for document processing management of claim 19 wherein the instructions for testing the identification data further includes instructions for testing the additional identifier data, whereby a status signal is generated therefrom.

21. The computer-readable medium of instructions for document processing management of claim 18 further comprising instructions for acquiring timing data representative of a duration of time during which the associated document has been placed in the temporary storage.

22. The computer-readable medium of instructions for document processing management of claim 21 further comprising:
instructions for communicating the status signal to at least one of a system administrator and a user associated with the processing of the at least one associated electronic document;
instructions for receiving additional identifier data in accordance with a communicated status signal; and
instructions for selectively releasing the associated electronic document from the temporary storage and deleting the document from the temporary storage in accordance with the timing data and the additional identifier data.

23. A computer-implemented method for document processing management comprising the steps of:
receiving document processing job data associated with processing of at least one associated electronic document, the document processing job data including an identification data segment adapted to communicate identifier data representative of at least one of a user identity and accounting information associated with the at least one electronic document;
testing the identification data relative to data representative of valid document processing jobs, including generating a status signal representative of at least one of missing identification data and invalid identification data;
generating a routing signal in accordance with the status signal so as to route the associated electronic document to an associated temporary storage after generation of the status signal; and
outputting the status signal as a notification that the associated document has been routed to the temporary storage.

24. The computer-implemented method for document processing management of claim 23 including the step of communicating the status signal to at least one of a system administrator and a user associated with the processing of the at least one associated electronic document.

25. The computer-implemented method for document processing management of claim 24 including the step of receiving additional identifier data in accordance with a communicated status signal.

26. The computer-implemented method for document processing management of claim 25 wherein the step of testing the identification data further includes testing the additional identifier data, whereby a status signal is generated therefrom.

27. The computer-implemented method for document processing management of claim 24 further comprising the step of acquiring timing data representative of a duration of time during which the associated document has been placed in the temporary storage.

28. The computer-implemented method for document processing management method of claim 27 further comprising the steps of:
communicating the status signal to at least one of a system administrator and a user associated with the processing of the at least one associated electronic document;
receiving additional identifier data in accordance with a communicated status signal; and
selectively releasing the associated electronic document from the temporary storage and deleting the document from the temporary storage in accordance with the timing data and the additional identifier data.

29. A document processing management system comprising:
means adapted for receiving document processing job data associated with processing of at least one associated electronic document, the document processing job data including an identification data segment adapted to communicate identifier data representative of at least one of a user identity and accounting information associated with the at least one electronic document;
testing means adapted for testing the identification data relative to data representative of valid document processing jobs, the testing means including means adapted for generating a status signal representative of at least one of missing identification data and invalid identification data;
operational control signal generation means adapted for generating an operational control signal to control the specified document processing after receipt of the status signal; and
means adapted for outputting the status signal as a notification that the associated document has at least one of missing identification data and invalid identification data.

30. A document processing management method comprising the steps of:
receiving document processing job data associated with processing of at least one associated electronic document, the document processing job data including an identification data segment adapted to communicate identifier data representative of at least one of a user identity and accounting information associated with the at least one electronic document;
testing the identification data relative to data representative of valid document processing jobs, the testing means including means adapted for generating a status signal representative of at least one of missing identification data and invalid identification data;
generating an operational control signal to control the specified document processing after receipt of the status signal; and
outputting the status signal as a notification that the associated document has at least one of missing identification data and invalid identification data.
